(19) United States
(12) Patent Application Publication
(10) Pub. No.: US 2004/0022380 A1
(43) Pub. Date: Feb. 5, 2004

(54) Method and system to validate payment method

(76) Inventors: Joe M. Lynam, Cupertino, CA (US); Ken R. Dawson, Pleasanton, CA (US); M. Brendan Philbin, San Jose, CA (US); Jennifer R. Truitt, Campbell, CA (US); Mikel A. Schwarz, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/209,288

(22) Filed: Jul. 31, 2002

(51) Int. Cl. H04M 3/42

(52) U.S. Cl. 379/207.13

(57) ABSTRACT

A method to validate a payment method for a sale via the Internet includes communicating selection data to a remote user terminal wherein the selection data provides the user with an option to select an ANI capture mechanism. The ANI capture method may include one or more of receiving a user-initiated communication, and initiating a communication with a telephone line number associated with a valid billing telephone number. The invention extends to transaction processing system and to merchant network equipment and transaction processing equipment.

### FIELD OF THE INVENTION

The present invention relates generally to the field of financial transactions where the charges for goods and/or services are billed to an account (e.g., a telephone account) and, more specifically, to method of, and merchant network equipment for, validation of a subscriber line of a telecommunication network.

### BACKGROUND OF THE INVENTION

In a transaction between a purchaser and a vendor (e.g., a merchant), if the purchaser wishes to pay using a credit card, the merchant typically obtains details of the credit card from the purchaser and verifies the transaction via a credit card gateway prior to finalizing the transaction. Certain vendors, in order to facilitate transactions with purchasers who do not have credits cards, may offer the option of having the charges related to a particular transaction applied to another account (e.g., a utility account) of the purchaser. It twill however be appreciated that some purchaser verification be associated with this payment option. For example, if the purchaser wishes to pay by applying a charge to a telephone bill, it is desirable to provide a method whereby the merchant can verify the transaction and the identity of the purchaser as in control of the payment instrument. Continuing the above example, currently telephone networks allow, under certain circumstances, a called station to capture the telephone number of a calling party. This feature is called automatic network identification (ANI). However, in some circumstances (e.g., in case of a sale via the Internet) ANI is not present.

### SUMMARY OF THE INVENTION

According to one aspect of the present invention, there is provided a method to validate a subscriber line of a telecommunication network. The method includes receiving a billing telephone number (BTN) associated with the subscriber line. A selection of one of a plurality of operations is received for a validation system to obtain line identification data of the subscriber line. The plurality of operations may include receiving an inbound communication at the validation system from a communication terminal associated with the subscriber line, and initiating an outbound communication from the validation system to the communication terminal associated with the subscriber line. Responsive to a selected operation, the line identification data of the subscriber line is obtained.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings.

FIG. 1 is a schematic block diagram of a system for processing a transaction concluded via the Internet.

FIG. 2 is a schematic representation of a system, in accordance with one embodiment of the invention, for processing a transaction via the Internet according to one embodiment of the present invention.

FIG. 3 is a schematic block diagram of transaction processing equipment according to one embodiment of the present invention.

FIG. 4 is a schematic diagram of the interaction between various participants in the transaction processing system according to one embodiment of the present invention.

FIGS. 5 & 6 show schematic representations of exemplary screen layouts provided by merchant network equipment to a user terminal.

FIG. 7 is a schematic operational flow diagram of the transaction processing equipment according to one embodiment of the present invention.

FIG. 8 is a schematic block diagram of a validation system to validate a transaction requested by a user to be billed to a telephone account according to one embodiment of the present invention.

FIG. 9 is a schematic flow diagram of the validation system to validate a transaction requested by a user to be billed to a telephone account according to one embodiment of the present invention.

FIGS. 10-12 is a schematic flow diagram of operations performed to identify a telephone number as a valid billable telephone number according to one embodiment of the present invention.

FIG. 13 is a schematic block diagram of a system to validate a transaction requested by a user via an inbound call mechanism according to one embodiment of the present invention.

FIG. 14 is a schematic block diagram of a system to validate a transaction requested by a user via an outbound call mechanism according to one embodiment of the present invention.

FIG. 15 is an illustration of an exemplary user interface to request a user to initiate an inbound call to the validation system.

FIG. 16 is a diagrammatic representation of information that may be maintained in an account for the purchaser as maintained by the customer management system, according to one embodiment of the present invention.

FIG. 17 is a diagrammatic representation of a machine in the exemplary form of a computer system within which a set of instructions, for causing the machine to perform any one of the inventive methodologies discussed herein, may be executed.

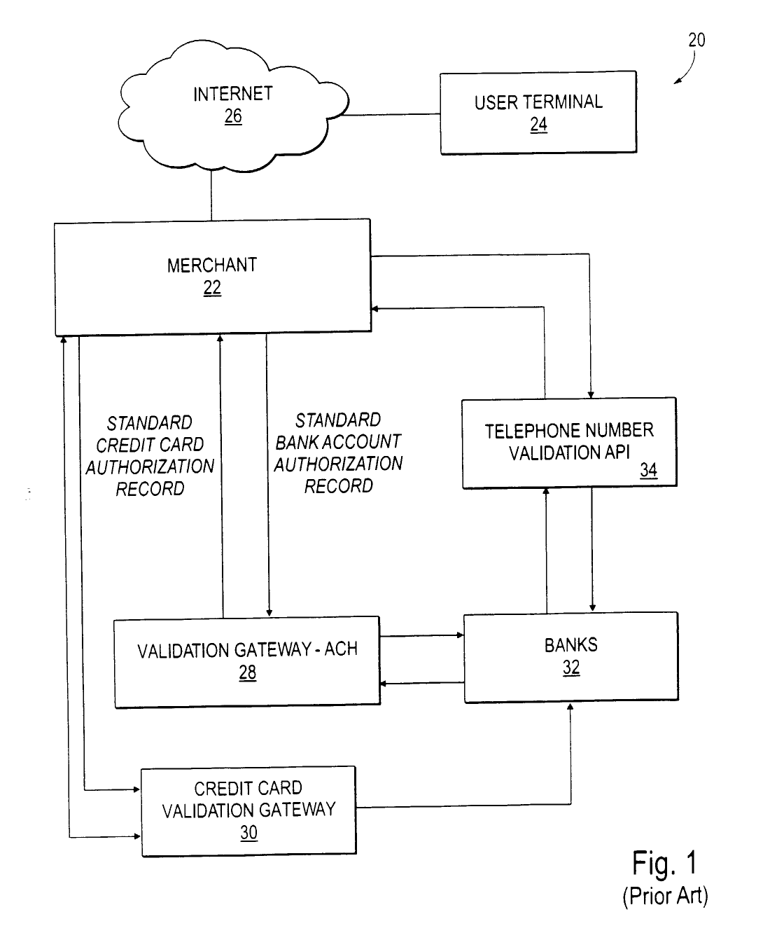

### DETAILED DESCRIPTION

In the following description, for purposes of explanation, numerous specific details are set forth in order to provide, a thorough understanding of the present invention. It will be evident, however, to one skilled in the art that the present invention may be practiced without these specific details.

Referring to the drawings, system 20 generally is a system for processing a transaction between a merchant 22 and a user or purchaser using a user terminal 24 (typically a personal computer or the like) via the Internet 26. When the user purchases goods and/or services (cumulatively referred to as products) via the Internet 26, the user is usually prompted to enter credit card or bank account details into the user terminal 24, which are then communicated via the Internet 26 to the merchant 22.

Dependent upon the mode of payment selected, the merchant 22 then communicates an authorization record, as commonly used in the industry, to an appropriate validation gateway 28, 30 or a telephone number validation application program interface (API). Usually, the merchant 22 first validates or checks whether or not the transaction can be processed by communicating with the validation gateway (28,30) or a telephone number validation API and, if so, the merchant 22 may then obtain payment for the transaction via an appropriate financial institution 32. Thus, the merchant 22 may be required to communicate a standard authorization record in the form of either a standard credit card authorization record or a standard bank account authorization record to a validation facility. Different records are thus communicated to different facilities dependent upon the particular payment method selected by the user.

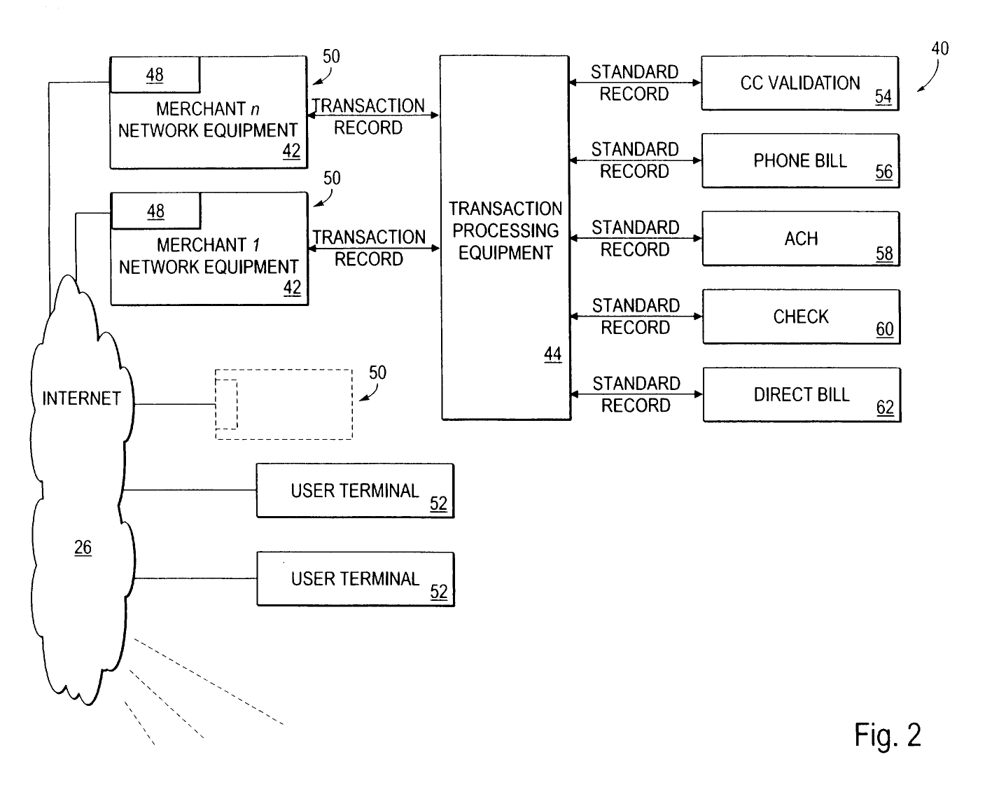

Referring in particular to FIG. 2 of the drawings, reference numeral 40 generally indicates a transaction processing system in accordance with one exemplary embodiment of the invention. The system 40 includes merchant network equipment 42, also in accordance with the invention, provided at different remote merchants 50, and transaction processing equipment 44, also in accordance with the invention, which is configured to communicate with the merchant network equipment 42 via communication lines 46. In the embodiment depicted in the drawings, the communication lines 46 are shown as dedicated communication lines. However, it is to be appreciated that the communication lines 46 may also form part of the Internet 26, as shown in broken lines in FIG. 2. The merchant network equipment 42 is connected via an Internet interface 48, which defines a user communication module, to the Internet 26 so that the merchants 50 can, via the merchant network equipment 42, offer products for sale to a variety of users via the user terminals 52 connected to the Internet 26. The user terminals 52 may be conventional personal computers (PCs) or the like. As described in more detail below, a user may select a variety of different payment methods to purchase goods via the Internet 26. The merchant network equipment 42 then communicates a transaction record, which includes an identifier to identify a particular type of payment method selected by the user to the transaction processing equipment 44. The transaction processing equipment 44 then creates a standard transaction record to be communicated to an appropriate validation and/or billing facility. When the transaction processing equipment 44 receives a response from the relevant facility 54-62, the response is then communicated via the processor module 64 to the merchant 50.

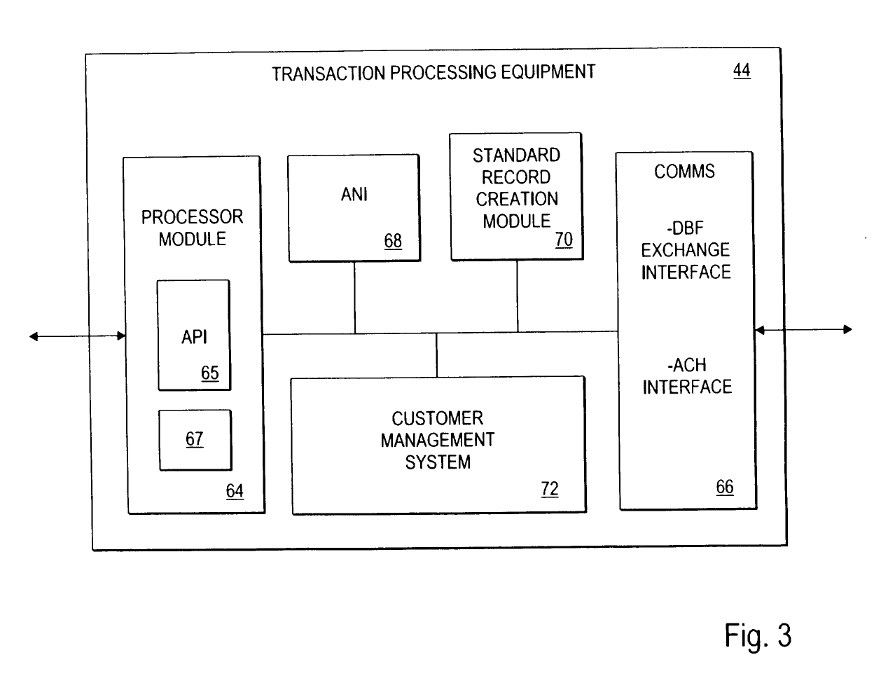

The transaction processing equipment 44 may include components illustrated in FIG. 3. The components may include a processor module 64. The processor module 64 may include a merchant communication module 67 to receive and identify a transaction record associated with any one of the account types which the user may select. The processor module 64 may also include a transaction record API 65, which, as described in more detail below, extracts relevant account data and account type identifiers from the transaction record received from the merchant, and creates an appropriate record. The record is then communicated via a financial service communication module 66 to a validation facility or a telephone bill validation API.

When responding to a validation request, the transaction processing equipment 44 typically includes a transaction record, which may include a following field:

| Field | Purpose/Description | Field Values |
|---|---|---|
| response | Response code returned to show | See Validation Response |
| | success or failure of a transaction. | below |

An example of a validation response communicated by the transaction processing equipment 44 to the merchant network equipment 42 is as follows:

Validation Response Example:
response
000 - transaction validated

The following parameters are typically returned for each local exchange carrier (LEC) specific (telephone account) validation request:

| | | Value | | |
|---|---|---|---|---|
| Parameter | Value | length | | |
| Key | Type | Max | Description | required |
| response | numeric | 3 | Response code. | yes |
| newarecode | numeric | 10 | Full phone number with | no |
| | | | new area code | |
| permissivedate | numeric | 8 | when new area code is | no |
| | | | effective, format is | |
| | | | yyyymmdd | |

The following is an example of a response to a merchant.

LEC Response Example:
response | newareacode | permdate
000 | 5103624000 | 20011231

The transaction processing equipment 44 may include an automatic line number identification (ANI) module 68, which automatically identifies a subscriber line from which the user terminal accesses the Internet 26. If the ANI module 68 is included but the ANI is not present or if the transaction occurs during a web-based interaction, the ANI capture may occur on an inbound call to or outbound call from the merchant or merchant equipment.

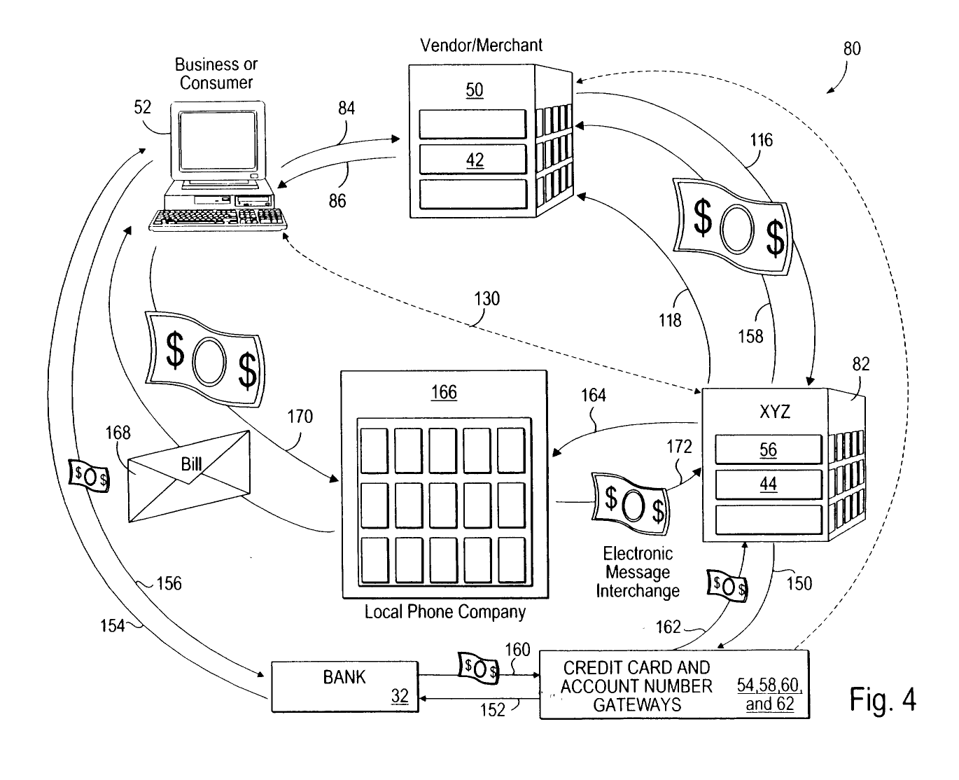

Referring in particular to FIG. 4 of the drawings, reference numeral 80 generally indicates a further embodiment of a transaction processing system in accordance with the invention. The system 80 includes components of the system 40 and, accordingly, the same reference numerals have been used to indicate the same or similar features unless otherwise indicated. In the system 80, a transaction processing facility 82 provides a one-stop transaction processing facility which a vendor or merchant 50 can use to authorize transactions, effect billing for transactions, and provide collection of funds for each transaction billed.

A purchaser or a user typically purchases products from the merchant 50 using the user terminal 52. The merchant 50 using its merchant network equipment 42 communicates data, as shown by line 86, to the user terminal 52, which provides the user with an option to purchase products using different account types.

Prior to finalizing any transaction, the merchant 50 typically requires validation of a particular account type, which the user has selected to secure payment. Accordingly, the merchant 50 communicates a validation request, as shown by arrow 116, to the transaction processing facility 82. In an exemplary embodiment, the request is in the form of a transaction record, which may include transaction type identification data as well as merchant identification data.

The transaction processing facility 82 then investigates an appropriate facility (e.g., the telephone bill validation facility 56) via its transaction processing equipment 44. The transaction processing equipment 44 communicates validation data, as shown by arrow 118, to the merchant network equipment 42 of the merchant 50. The merchant network equipment 42 communicates an appropriate response to the user terminal 52, dependent upon whether or not the transaction has been validated. In a case where a telephone bill payment option was identified as valid and where ANI is not present, the ANI is captured subsequently during an inbound call from, or outbound call to, a telephone number associated with a successfully validated BTN. The choice is presented to a user to select an option of an inbound or an outbound telephone call.

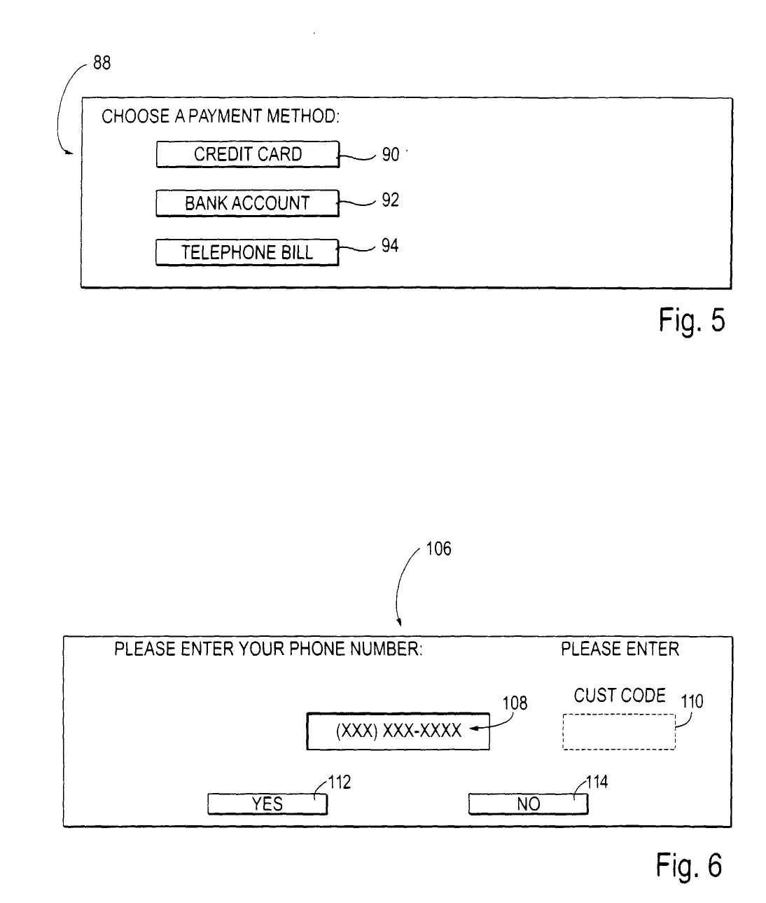

Once the user has selected a product, which the user wishes to purchase (see line 84), the merchant network equipment 42 communicates a choice of payment methods. FIG. 5 illustrates an exemplary screen layout 88 for display on the user terminal 52.

The screen layout 88 includes various payment method selections including a telephone bill button 94. The user may then select which particular account type he or she wishes to use to effect payment for the purchase and, dependent upon which particular button is activated, a further screen layout is provided by the merchant network equipment 42.

If the user wishes to charge the purchase to a telephone account or a telephone bill, the user activates the telephone bill button 94 and, in response thereto, a telephone detailed screen layout 106 is provided on the user terminal 52. FIG. 6 illustrates an exemplary screen layout 106. The screen layout 106 requires the user to enter the user's telephone number in field 108, as well as a customer code in field 110. The telephone number is user entered and then is compared to the captured ANI (if available). The user is then required to confirm the telephone number by activating either the “YES” button 112 or the “NO” button 114. If the “NO” button 114 is activated, then the user may be required to re-enter the telephone number in the field 108. If, however, the “YES” button 112 is activated the information is then communicated to the merchant network equipment 42.

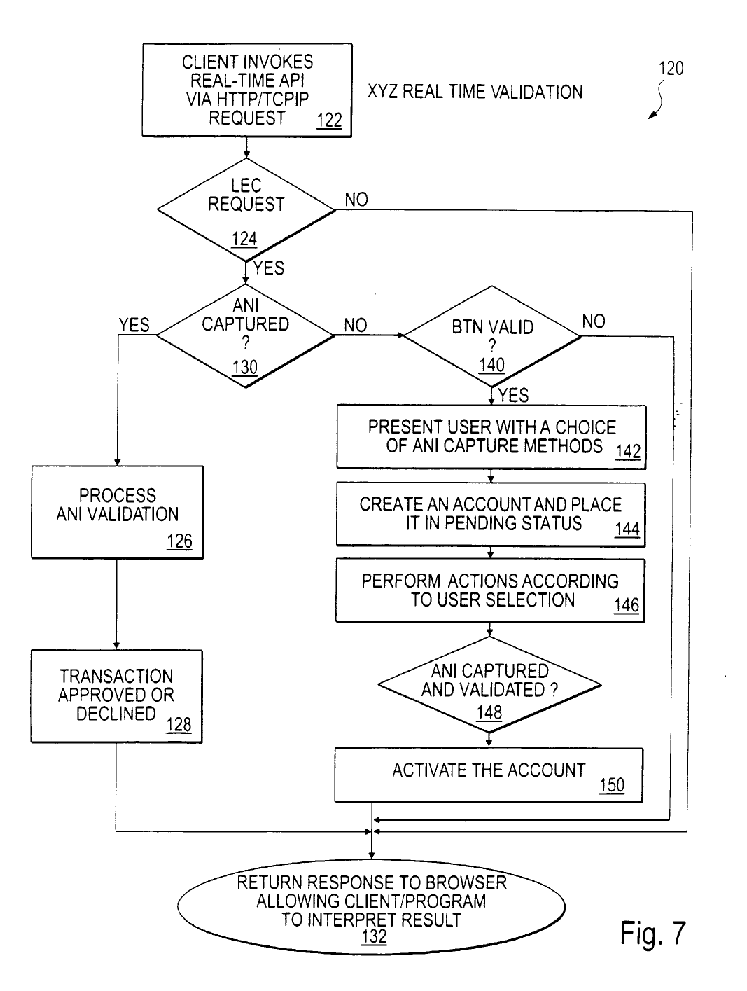

When ANI is unavailable or not captured, then the telephone number may be collected and validated for its billing status. Further details regarding ANI capture mechanisms are provided with reference to FIG. 7. Reference numeral 120 of FIG. 7 generally indicates a schematic operational flow diagram of a validation process 120 which is carried out by the transaction processing equipment 44. The validation process 120 may be carried out in real-time and may be invoked by a merchant using its merchant network equipment 42 via a HTTP/TCPIP request as shown at block 122. The processor module 64 of the transaction processing equipment 44 analyzes the transaction record and identifies which particular account type has been selected at block 124. The transaction record may include an indicator defined by indication data, as shown below, to identify an account type chosen by the user:

| Validation Type | Purpose/Description | Indicator |
|---|---|---|
| LEC/Phone Bill | Perform LEC Validation | 01 |
| Credit Card | Perform Credit Card Authorization | 04 |
| ACH | Perform ACH Routing Number Check | 05 |

The transaction record API 65 parses the transaction record and extracts relevant identification data to determine a specific account type that a user has selected (see block 122). Once the account type has been identified at decision block 124, the API 65 extracts the telephone number associated with the subscriber line number (e.g., ANI) at block 130. The validation procedure is then carried out as shown at block 126. The transaction is then either approved or declined as shown at block 128 and an appropriate response is returned to the browser at block 152 initiating the request at the merchant network equipment 42. It will however to be appreciated that the validation inquiry may also be effected by a user activating an appropriate hyper-link on a display screen of the user terminal 52 so that the validation process may take place via a direct communication between the user terminal 52 and the transaction processing equipment 44 at the transaction processing facility 82. Typically, the response to a validation request is communicated to the merchant network equipment 42 and, accordingly, as shown at block 152, the transaction processing equipment may communicate a response to the browser of the merchant network equipment 42. The merchant network equipment 42 may then interpret or react upon an approval or a declining of the transaction.

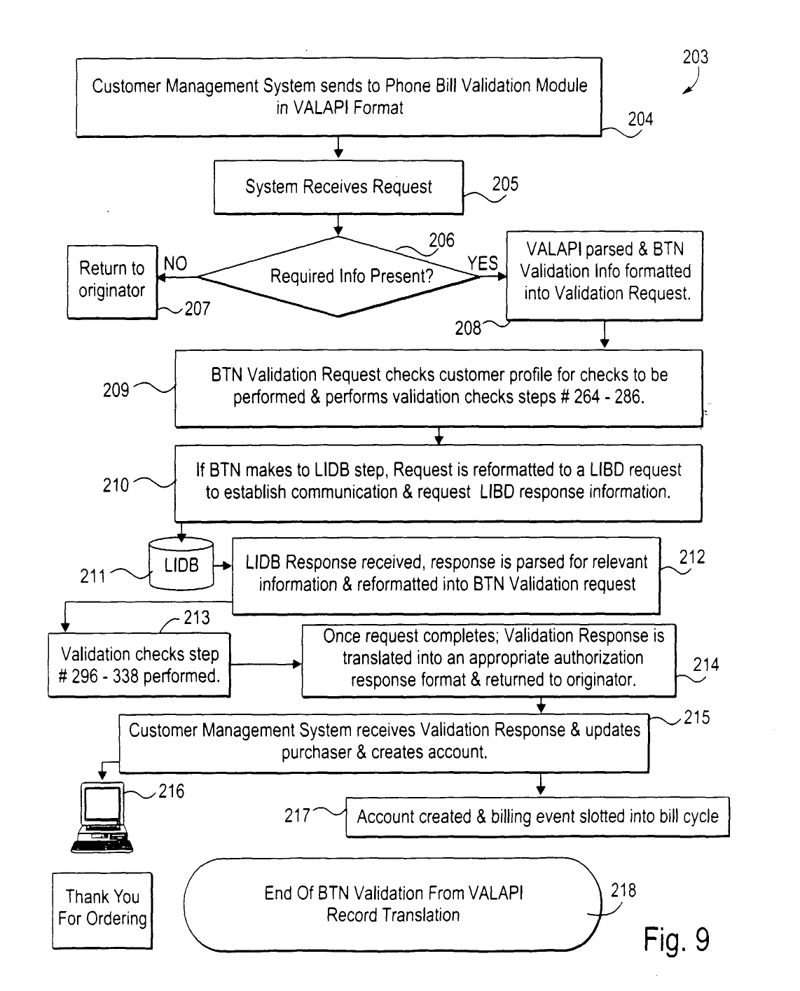

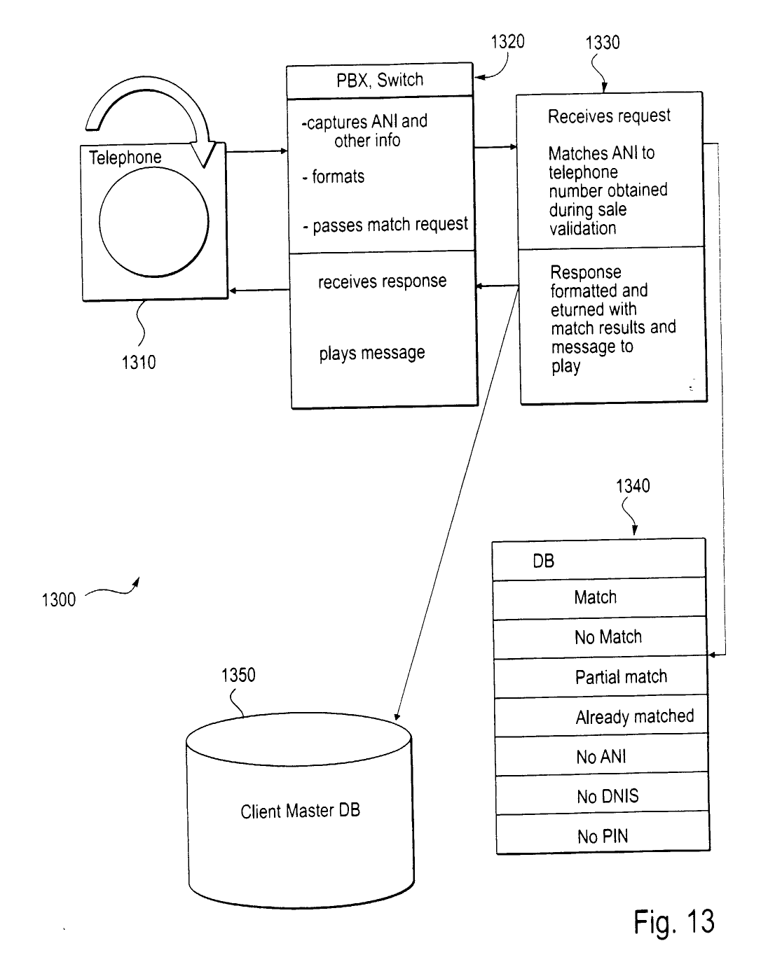

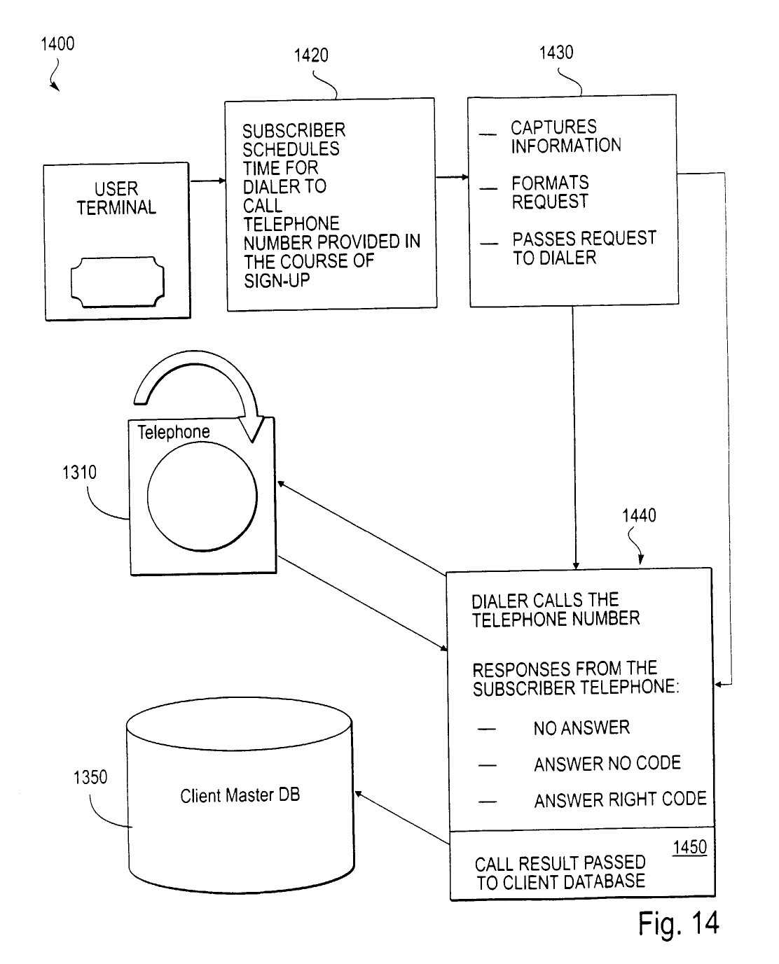

When the user chooses to use a telephone account as a payment method (or instrument) and an ANI is unavailable or not captured (determined at block 130), then the telephone number may be collected and validated for its billing status at block 140. Further details of the operations performed to validate BTN are represented diagrammatically at FIG. 9. Returning to FIG. 7, if the telephone number is identified as a valid BTN (block 140), then the ANI is captured subsequently during an inbound or an outbound call to the validated telephone number. The choice is presented to a user (e.g., a purchaser or a merchant) at block 142 to initiate a telephone call to, or to receive a telephone call from, the validation system. Once the user makes a selection between the choices presented at block 142, a customer account is created in the customer management system 72 and placed in a pending status at block 144. At block 146 the validation system performs actions according to user selection. Examples of such actions to capture an ANI are described in more detail with reference to FIG. 13 and FIG. 14, and include, for example, requesting the user to initiate an inbound call to a validation system using a communication terminal (e.g., telephone set) associated with a subscriber line identified by the validated telephone number, or initiating an outbound call from the validation system to a communication terminal coupled to the subscriber line. Responsive to a positive determination at block 148, the customer account is activated as shown at block 150.

For an outbound call request to capture the ANI, a screen may be provided at block 142 to capture relevant data to schedule a telephone call event to the telephone line number associated with the BTN provided by the user (e.g., a merchant or a purchaser).

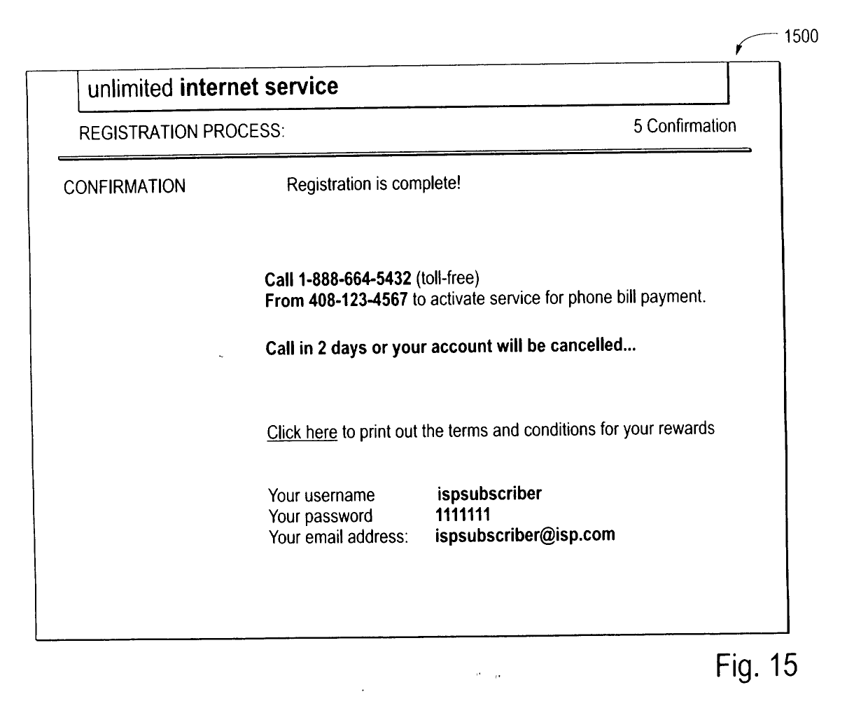

FIG. 15 is a screen shot 1500 illustrating an exemplary user interface whereby a user may be requested to initiate an inbound call to the validation system.

The results of the ANI capture event may be relayed to the merchant.

For an outbound call request to capture the ANI, a screen may be provided at block 142 to capture relevant data to schedule a telephone call event to the telephone line number associated with the BTN provided by the user (e.g., a merchant or a purchaser).

The results of the ANI capture event may be relayed to the merchant so that the merchant can update customer records, and initiate billing.

Regardless of a method selected by the user to capture an ANI, an account may be created in the customer management system 72 and placed in a pending status awaiting ANI capture event at block 144.

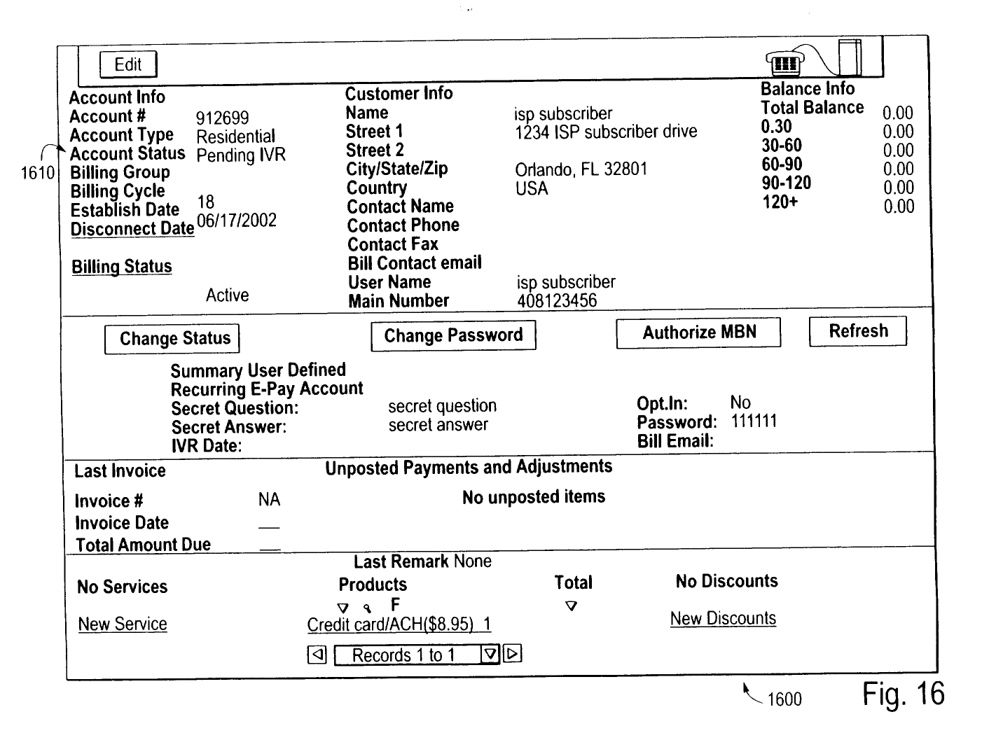

FIG. 16 illustrates a screen 1600 depicting information that may be maintained in an account for the purchaser as maintained by the customer management system 72. The pending status of the account is indicated in field 1610.

Once the ANI capture event has taken place successfully, the result is transmitted to the customer management system 72 and to the appropriate entities to fulfill the order. The account status is then updated with the new information. Once the account becomes active, the active status of the account is indicated in field 1610.

While this document specifically refers to a payment method using a telephone account, an activation mechanism has application to other payment methods or instruments not described herein.

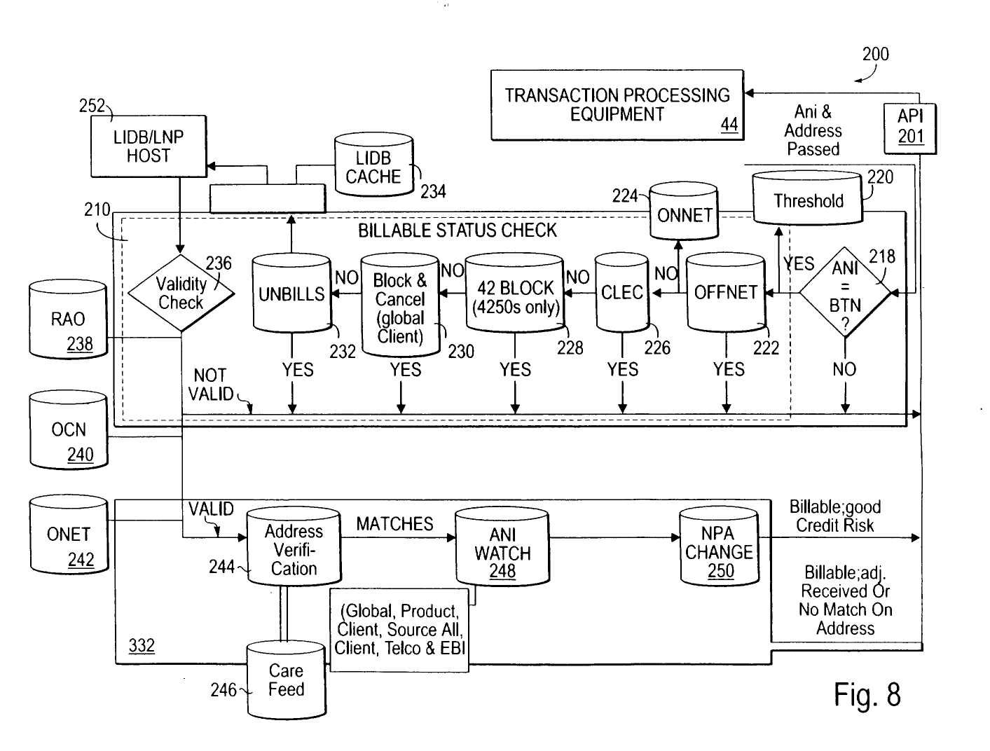

Specifically when attempting to charge a transaction to a telephone account, a validation system 200 diagrammatically represented at FIG. 8 ensures that the local exchange carrier (LEC) has a billing arrangement with the transaction processing facility 82.

An example of an HTTP validation request received by the transaction processing equipment 44 is as follows:

Validation Request Example:
http://validationurl/servlet?valtype=00&clientid=7
000

The parameters in the request are as follows according to an exemplary embodiment of the present invention:

| Parameter | | Value | | |
|---|---|---|---|---|
| Key | Value Type | length Max | Description | required |
| Id | numeric | 4 | Client ID | yes |
| valtype | numeric | 2 | Validation Type - | yes |
| | | | LEC, CC, ACH | |
| Pass | alphanumeric | 30 | Password assigned | no: |
| | | | to client | |
| name | alpha | 30 | Name | no |
| street1 | alphanumeric | 30 | Street | no |
| street2 | alphanumeric | 30 | Street | no |
| city | alpha | 30 | City | no |
| state | alpha | 2 | State | no |
| zip | numeric | 5 | Zip | no |
| zip4 | numeric | 4 | ZipPlus4 | no |

In addition to the parameters outlined above, the following parameters may be used when performing a LEC validation request:

| | | Value | | |
|---|---|---|---|---|
| Parameter | Value | length | | |
| Key | Type | Max | Description | required |
| ani | numeric | 10 | Number to be validated, | yes or btn |
| | | | required unless btn is | |
| | | | present | |
| btn | numeric | 10 | Number to be validated, | yes or ani |
| | | | required unless ani is | |
| | | | present | |
| dni | numeric | 10 | | no |
| clientid | numeric | 4 | Customer id | yes |

An example of an HTTP validation request when the user has selected a telephone account to pay for his or her purchases is as follows:

LEC Request Example:
http://validationurl/servlet?valtype=01&
clientid=7000&ani=4083624000

Referring in particular to FIG. 8 of the drawings, the validation system (or module) 200 includes an application program interface (API) 201 that is connected to the transaction processing equipment 44. In addition, it is however to be appreciated that the API 201 may be connected to a variety of different hosts or clients which require validation of a subscriber line via which the remote terminals 52 carry out transactions for products via the Internet 26.

The transaction processing equipment 44 communicates the telephone number of the subscriber line to the module 200, which then processes the information and provides a validation status, e.g. a code indicating a valid billable number or a code indicating that the line number is not a valid billable number (unbillable or non-billable). In particular, a plurality of codes associated with various statuses of the subscriber line is communicated to the transaction processing equipment 44 as described in more detail below.

The module 200 includes hardware and software to implement the invention. In particular, the module 200 includes a comparator module 218, a threshold database 220, an OFFNET database 222, an ONNET database 224, a competitive local exchange carrier (CLEC) database 226, a 42 BLOCK database 228, a block and cancel database 230, an unbilled and/or unpaid bills database 232, line identification database (LIDB) short term cache 234, a validity check module 236, a regional account office (RAO) database 238, an operating company number (OCN) database 240, an ONET database 242, an address verification database 244, customer account record exchange (CARE) results database 246, an ANI watch database 248, and an NPA (Numbering Plan Area) exchange database 250. It is to be appreciated that, in less sophisticated embodiments of the invention, all of the above databases need not be included. However, for enhanced accuracy, all of the above databases are preferably included. Further databases may also be included further to increase the reliability of the validation process.

In addition to any one or more of the above databases, the module 200 is in communication via a conventional communication channel with an offsite or, in some embodiments, on-site line identification database (LIDB) host 252. The LIDB host 252 may include a line number portability (LNP) database. Typically, the LNP database may front end access to a plurality of industry standard LIDBs (e.g., 13 different LIDBs). The LNP database may however be a separate database. As described in more detail below, the module 200 communicates the subscriber line number to the LIDB host 252, which, in turn, communicates reference subscriber data in the form of industry standard LIDB codes back to the module 200 for processing. The module 200 then processes the LIDB codes to provide the merchant 84 with validation data relating to the purchase or transaction based on subscriber line. Unlike conventional LIDB applications which use a LIDB to make decisions regarding destination subscriber lines or call completion decisions, e.g., decisions for calling cards, collect and third party toll services or the like, the module 200 is used to identify telephone numbers of originating subscriber lines.

Broadly, the module 200 includes a processor module 202 that includes the various databases 220 to 232 as well as a comparator module 218 and a validity check module 236, and an interrogation module 256 for interrogating the LIDB host 252. One or more servers with associated databases may define the aforementioned modules. Further, in the example illustrated, the LIDB host 252 is shown as a single database but may comprise many different LIDB databases maintained by various LECs and, accordingly, may be located at various different geographic locations.

Once the transaction between the merchant and the user has been concluded, typically after a successful authorization or a validation event as described above, a charge is then billed to a particular account type which the user (e.g., purchaser) has selected.

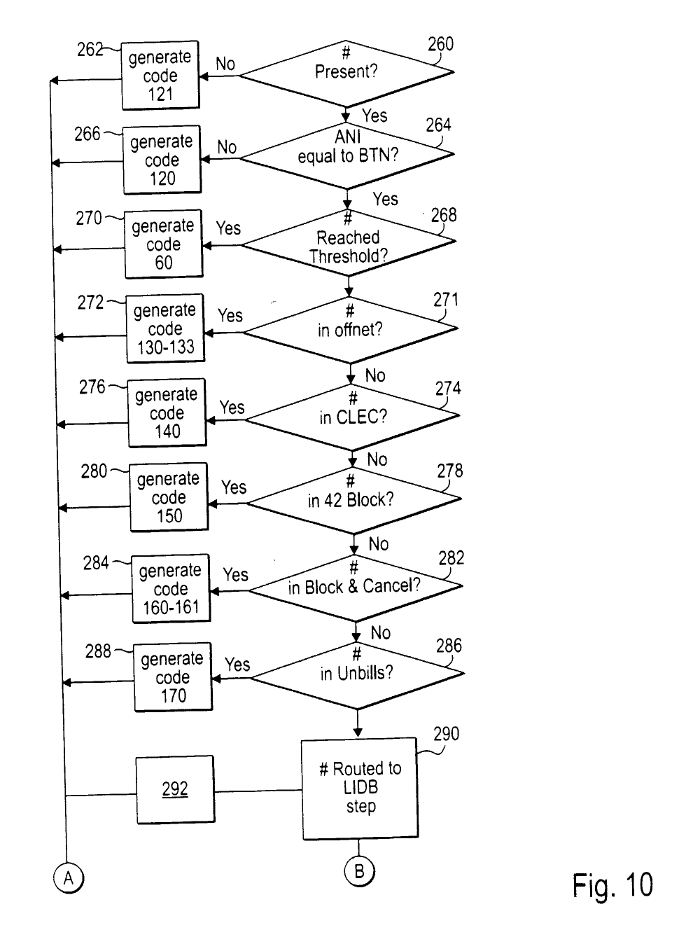

In FIG. 9 of the drawings, reference numeral 203 generally indicates a validation process carried out by the validation module 200. The customer management system 72 (see FIG. 3) sends the transaction or billing record to the module 200, as shown at block 204. The module 200, when it receives the validation request at block 205, has its processor module 202 first check (see block 206) if all the information required for validation has been furnished by the merchant network equipment 42 and, if not, the request is returned to the merchant 50 as shown at block 207. If, however, all the information required by the module 200 is present in the record, the record is then parsed and the BTN is extracted from the record and formatted into a validation request as shown at block 208. Thereafter, the module 200 performs various checks, described in further detail with reference to FIG. 10, during which the subscriber line is validated (see block 209). If the BTN progresses to a LIDB interrogation operation, the request is then reformatted into a LIDB request to obtain LIDB response information (see block 210). The LIDB database 211 is then interrogated and the LIDB response is received and parsed for relevant information whereafter it is reformatted into a BTN validation request as shown at block 212. Thereafter, and as described in more detail below, the processor module 202 performs further validation checks (see block 213). Once the request has been investigated, the various databases have been interrogated, and the results retrieved therefrom processed, the processor module 202 then translates the validation response into an appropriate response that is communicated to the transaction processing equipment for communication to the merchant (see block 214). The Customer Management System 72 updates purchase data, and creates an account for the user as shown at block 217. Thereafter a display screen is communicated to the electronic terminal that thanks the user for ordering the product. Typically, each transaction defines a billing that is recorded at the merchant, and, together with other billing events, each transaction is communicated to the transaction processing facility at the end of a billing cycle (see block 218).

An exemplary embodiment of a validation procedure, in which a subscriber line is associated with a telephone account, is described with reference to FIGS. 10-14.

As described above, the transaction processing equipment 44 initiates a request to the validation module 200 to validate a transaction between a vendor and a user (e.g., a purchaser) to be included in a telephone bill associated with the subscriber line. The module 200 first checks to see if the BTN number is present in the request from the transaction processing equipment 44 and, if no number is present, a return code 121 is generated and communicated to the transaction processing equipment 44 as shown at block 262 of FIG. 10. A code is generated to indicate that the module 200 is unable to process the request. If, however, the number is present in the request, the module 200 then checks if the line number captured (hereinafter also referred to as the ANI) by the ANI capturing module, and the BTN entered on the display screen match, as shown at block 264. If, however, the ANI and the BTN do not match, then the processor module 202 generates a code to indicate that the caller and the owner of the line number are not the same person (e.g., the user enters the user's BTN in the display screen and uses an electronic terminal connected to a different subscriber line and is thus calling from a different ANI) and the relevant modified code is then returned to the transaction processing equipment.

If the ANI and the BTN do match, the processor module 202 interrogates the threshold database at block 268 to ascertain whether or not the line number has reached its threshold (e.g., a predefined client threshold parameter such as an account expenditure threshold). If the line number has reached its threshold, the processor module 202 then generates a code, as shown at block 270, which is then communicated to the transaction processing equipment 44 to indicate that the line number may not be granted service. In other words, the subscriber account cannot be billed for the goods and/or services requested by the user from the merchant 84.

If the threshold has not been reached, the module 200 then interrogates its OFFNET database 222 (see block 271) to check if the industry standard NPA/NXX and operating company number (OCN) of the subscriber line is present in the OFFNET database 222. The OFFNET database 222 includes NPA /NXX and OCN combinations of operating companies with which the proprietor or user of the module 200 does not have billing and collections agreements to bill into the telephone company's (Telco's) bill page associated with the subscriber line. Accordingly, the transaction processing facility 82 is unable to include a charge in the account associated with the subscriber line on behalf of the merchant for the transaction.

If the line number is in the OFFNET database 222, then the processor module 202 generates a plurality of codes (see block 272) and communicates these codes to the transaction processing equipment 44. The codes indicate that the NPA/NXX and OCN for the particular line number are not billable and, accordingly, charges for goods and/or services requested by the user cannot be included in a monthly telephone account by the module 200. The codes provide an indication to the transaction processing equipment 44 why the subscriber line is not billable or deliverable. If the subscriber line number is not included in the OFFNET database 222, a check is conducted to see whether or not the subscriber line number is included in the ONNET database 242. This check is however optional in the embodiment depicted in the drawings, but may be mandatory if the module 200 does not include the OFFNET database 222.

Thereafter, as shown at block 278, the processor module 202 checks to see if the line number is found in a known CLEC table in the CLEC database 226. CLEC numbers are those line numbers that are known to have ported to a CLEC and, accordingly, the proprietor of the module 200 is thus unable to route these line numbers to the correct billing entities. If the line number is found in the CLEC database 226, then the processor module 202 generates a code (see block 276) that is communicated to the transaction processing equipment 44. The code indicates that the BTN provided by the user is not billable for the CLEC and the module 200 can thus not charge the transaction to the subscriber account associated with the subscriber line.

If the line number is not found in the CLEC database 226, then the module 200 checks to see if the subscriber of the subscriber line has requested a 4250 billing block as shown at block 278. In particular, the processor module interrogates the 42 BLOCK database 228 and, if the number is located in the database 228, which indicates that monthly recurring charges (4250) charges are prevented from being billed to that line number, the processor module 202 generates a code (see block 280) which is communicated to the transaction processing equipment 44 to indicate that billing to the particular subscriber line has been blocked.

If, however, the subscriber line has not been blocked, the module 200 then checks, at block 282, if the line number is located in the block and cancel database 230 and, if so, the processor module 202 generates a plurality of codes which are then communicated to the vendor as shown at block 284. The block and cancel database 230 includes requests from owners of subscriber lines, agencies, businesses, or the like that a service be canceled or blocked from further billing. Thereafter, the module 200 interrogates the unbilled and/or unpaid bills database 232, as shown at block 286, to check if there is a history of any unpaid bills and/or unbillable bills associated with the subscriber line. Unbillable bills relate to those subscriber line numbers where previous attempts have been made to bill charges to the subscriber account associated with the line number, and which have been returned as unbillable. If the processor module 202 locates the line number in the unbillable and/or unpaid bills database 232, then, as shown at block 288, a code is generated and communicated to the transaction processing equipment 44 to indicate that the line number was previously found to be unbillable and is still considered to be unbillable.

The process described above conducts a preliminary investigation into the subscriber line number or ANI/BTN to provide an initial indication of whether or not the ANI/BTN corresponds with a billable subscriber line. Once the initial investigation has been conducted, the module 200 then uses the ANI to obtain reference subscriber line data in the form of LIDB codes from one or more industry standard databases in the form of the LIDB host or database.

As shown at block 290, if the ANI is not found in the LIDB database 252, the module 200 cannot provide any validation data to the transaction processing equipment 44 on this subscriber line and an appropriate code is then communicated to the transaction processing equipment 44 as shown at block 292.

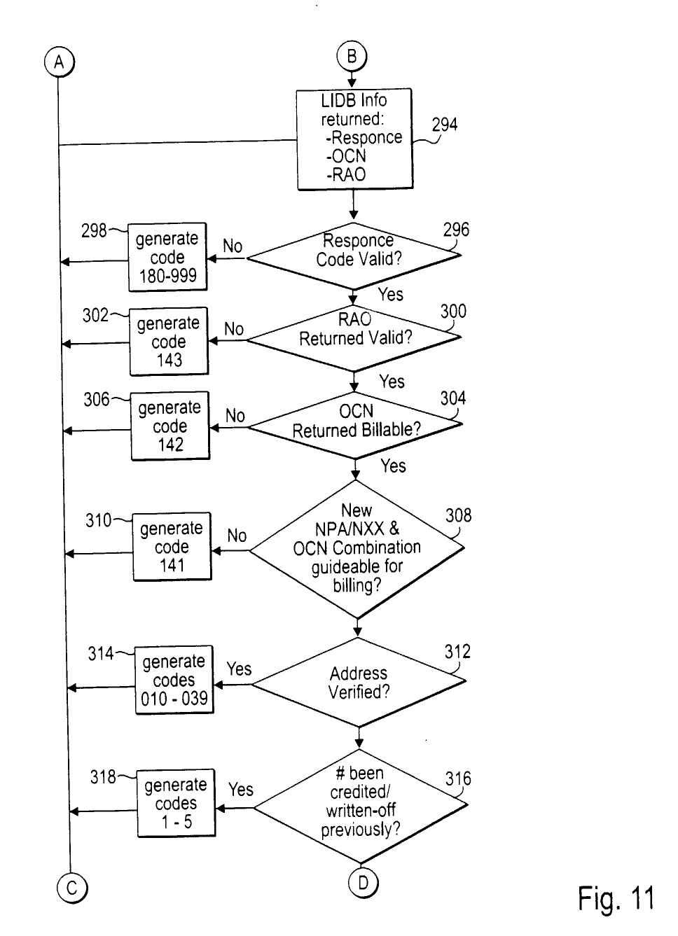

Once the LIDB database or host 252 has been interrogated, it returns industry standard LIDB codes and line number portability (LNP) data to the module 200 as shown in block 294 of FIG. 11. The LIDB codes are then mapped or translated by the processor module 202 into modified validation codes that provide relevant validation information to the transaction processing equipment. The same modified validation code can be generated from a plurality of different LIDB codes. Once the LIDB information codes have been returned to the processor module 202, the LIDB codes, including OCN and RAO response codes, are fed into the validity check module 236.

As mentioned above, the LIDB host may also provide LNP data to the module 200. The LNP data is used to identify subscriber line numbers that have ported to a CLEC. If a subscriber line has been ported to a CLEC, the billing ONNET status of the CLEC is verified in the CLEC database. The LNP identifies the facilities based CLECs which are CLECs that have been assigned all the line numbers for an NPA/NXX in a specific geographic territory. This type of CLEC would be in control of the cable, dial tone and billing envelope for that number. Typically, the LNP cannot be used to identify CLEC sellers that have resold the subscriber line under their brand, but still lease the cable and tone from an incumbent local exchange carrier (ILEC). Accordingly, the transaction processing facility 82 may be unable to process transaction data onto a bill page or telephone account of the CLEC reseller bill page. In order to identify reseller CLECs, the module 200 compares RAO and OCN information, returned from the LIDB host, to data in the ONNET database. The OCN is the local Telco that owns the subscriber line number and the RAO is the office of the Telco that is responsible from a billing standpoint for the subscriber line number.

If the validity check module determines that the response codes are invalid, the module 200 generates a plurality of modified codes (see block 298) which are communicated to the requestor or transaction processing equipment 44 to indicate that the mapping of the LIDB codes to the modified codes concluded that the line is an unbillable subscriber line.

If the validity check module 236 confirms the validity of the LIDB codes and, in the event of the line number being a billable line number, the processor module then checks the RAO database 238 to ascertain whether or not the RAO is billable, as shown at block 300. If the RAO is not billable, then the processor module 202 generates and communicates a return code (see block 302) to indicate to the transaction processing equipment 44 that the line number belongs to a CLEC that is not billable by the module 200.

In a similar fashion, at block 304, the processor module 202 checks to see if the OCN returned from the LIDB host 252 corresponds with a known CLEC or if the OCN corresponds with an OFFNET OCN and is therefore also unbillable. If the line number corresponds to an OCN that is not billable, a return code is generated by the processor module 202 and communicated to the transaction processing equipment 44 (see block 306).

If the subscriber line number has passed the RAO and OCN checks and, accordingly, it appears that the number is billable, the processor module 202 then checks to see if a new NPA/NXX and OCN combination for this line number is guidable to the correct local Telco for billing (see block 308). If the line number is not guidable, then the module 200 generates a code at block 310 that is communicated to the transaction processing equipment to indicate that, even though the line number is billable, the transaction processing facility is unable to guide the billing information to the new Telco for billing. Accordingly, the telephone number is in fact non-billable insofar as the transaction processing facility is concerned and a decline status is therefore communicated to the transaction processing equipment.

The abovementioned operations are carried out to ascertain whether or not the subscriber line can be billed for the goods and/or services requested. However, to enhance the accuracy or reliability of the module 200, further checks or verification are conducted as described below.

In the event that the subscriber line number has passed or complied with the abovementioned checks, and has thus not yet been rejected, the module 200 performs address verification procedures at block 312. The module 200 then interrogates an address verification database 244 to compare the address or location data (e.g. a ZIP code) supplied by the user via a display screen on the terminal with reference address data as shown at block 312. If, however, the address supplied by the user does not match with the address in the verification database or, the addresses are not within a predefined range or area, the processor module, as shown at block 314, generates a plurality of codes that are then communicated to the transaction processing equipment to indicate the level of likelihood that the caller (ANI) and the account owner are the same person.

During the address verification block 312, the module 200 interrogates a customer account record exchange (CARE) database (which can be an on-site database which is regularly updated), to provide enhanced reliability. In particular, the CARE database or information site is typically one or more industry standard offsite databases that allow consumers to select or change their long distance service provider. Local Telcos forward specific customer information to the LEC associated with the subscriber. The information communicated typically includes a new phone number, billing address, installation date, the person or organization responsible for the account, or the like.

As shown at block 316, the module 200 interrogates the CARE database or information site and CARE data is then loaded into CLEC and new line databases to perform certain fraud and billing checks. The CARE information investigation occurs after a successful validation event. Once the module 200 has validated the subscriber line, the subscriber line number data is sent to a CARE database provider hosting the CARE database to obtain the BNA and age of the account. The information is typically returned within 48 hours and then processed. Care records that are returned without BNA and CLEC ACCOUNT codes are inserted into the CLEC database for future reference. Accordingly, if the BTN is presented again at a later date, it will fail the CLEC check operation (see block 274 in FIG. 10).

The ANI watch database 248, which includes historical and adjusted information, is used by the module 200 to determine if the account has previously been adjusted (see block 316). Typically, this operation includes ascertaining previous requests by the subscriber for credit, obtaining data on any written off amounts for charges that were billed to a bill page, or the like.

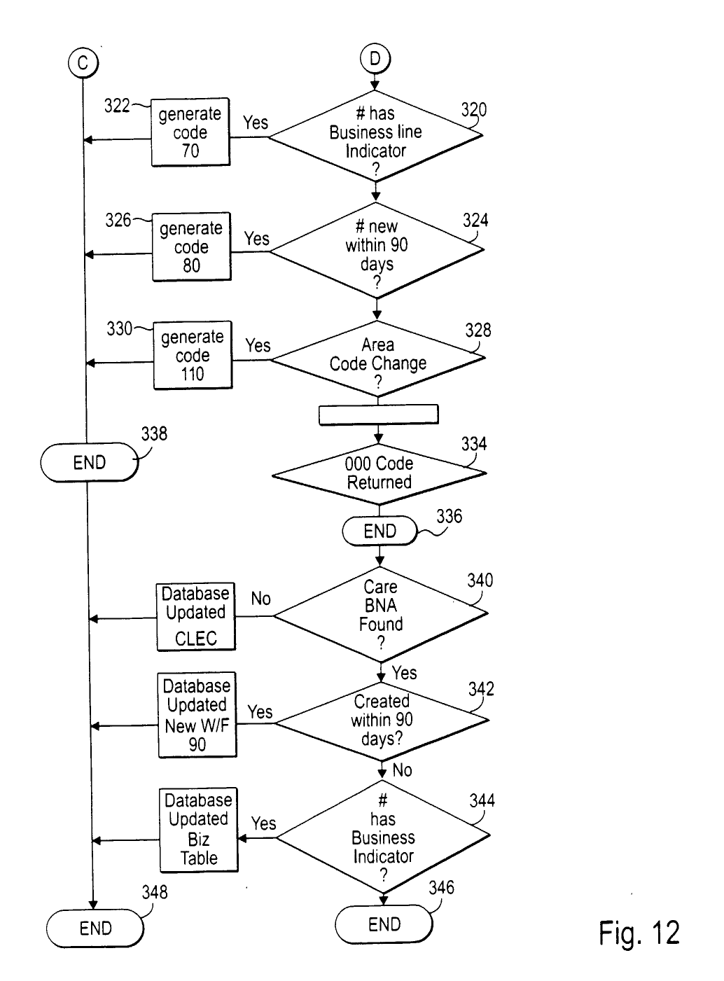

If adjustments have previously been made to the account associated with the subscriber line, the processor module 202 generates a plurality of codes (see block 318) to indicate to the transaction processing equipment 44 that the adjustments have been made. If no adjustments have been made, the processor module 202 checks to see whether or not the line number has a business line indicator as shown at block 320 in FIG. 12. If the business line indicator is active, the module 200 generates a code (see block 322) that is communicated to the transaction processing equipment 44 to advise that the line is a business line. Thereafter, as shown in block 324, the processor module 202 checks to see if the subscriber line number has been in service for less than about 90 days and, if so, a return code (see block 326) is generated to advise the transaction processing equipment 44 who may then selectively decide whether or not to conclude the transaction. A database of new numbers may be updated with the new number.

Thereafter, the module 200 interrogates the ANI watch database 248 (see block 328) to ascertain whether or not the area code of the line number has been changed or is scheduled to change. This interrogation is typically for billing purposes only and is not used to decide upon the validity of the request. In this operation, the transaction processing equipment 44 requesting the validation typically updates the billing file with the new area code number, and the processor module 202 generates a code (see block 330) to advise the transaction processing equipment 44 of the scheduled change to the area code.

Once the line number has passed all the aforementioned checks, the module 200 then concludes that the subscriber line obtained using ANI techniques is in fact a billable line and, accordingly, the transaction may be charged directly to the account of the subscriber. Accordingly, the module 200 then generates a code (see block 334) that is communicated to the transaction processing equipment 44. This code defines an approved status following both a billable line number enquiry as well as several fraud checks which are carried out by the fraud control module. If the line number has passed the abovementioned checks and the return code is generated, the process terminates at block 336. Thus, block 336 defines the end of the process during which the various checks have been conducted on the subscriber line to assess whether or not it is a billable subscriber line that charges may be billed to. Block 338 defines the last operation to which the process jumps when, at any point during the abovementioned process, the line number is found not to be billable (e.g., a creditworthy decision was requested by the transaction processing equipment) and the inquiry is accordingly terminated and the relevant code is communicated to the transaction processing equipment 44.

The abovementioned operations are typically executed in real time, but may also be performed in batch mode. However, information sources that do not allow checks on the line number in real time may be are carried out subsequently on the line number. Typically, once the real time evaluation is carried out and the return code is communicated to the transaction processing equipment 44, and the vendor and user proceed with the transaction, transaction data is then periodically returned to the module 200 by the transaction processing equipment 44 for a pre-billing validation check or actual billing. During actual billing the module 200 accesses an account folder of the subscriber line at the Telco and inserts the charges due to the transaction processing equipment 44 into the telephone account. As shown at block 340, line numbers are sent to the CARE database 246 to determine if the BNA is available at the local Telco. If the folder or telephone account is not available, the local Telco typically sends the BNA and codes as to why the number is unavailable to the transaction processing facility. If the BNA is found in the CARE database 246, the processor module 202 then checks to see whether or not the account was created within the last 90 days as shown at block 342. If the account was not created within the last 90 days, then the business indicator is checked as shown at block 344 and the process ends as previously shown at block 346. If, however, the number was found in the CARE database 246, the account was created within the last 90 days, or has an active business indicator then the module 200 generates the appropriate codes that are communicated to transaction processing equipment 44 and the process terminates as shown at block 348.

As it was stated above, if a user selected a third party account (e.g., a telephone bill) payment option and ANI is not available (e.g., a sale is taking place via the Internet), the user (e.g., a purchaser or a merchant) is presented with a choice of ANI capture methods at block 142 of FIG. 7. The choices offered may include an inbound telephone call option and an outbound telephone call option. FIG. 13 shows a diagrammatic representation of components, which may be involved in effectuating receiving of an inbound telephone call according to an exemplary embodiment of the present invention. It should be noted that the components 1320, 1330, and 1340 represented in FIG. 13 may be associated with or even included in the transaction processing facility 82 (see FIG. 4). Additionally, communication between the telephone 1310 and the PBX switch may be effectuated via a local telephone company 166 (see FIG. 4). When the user selects an inbound call as an ANI capture method, the user is issued a personal identification number (PIN) to be used when the inbound telephone call is effectuated. The user initiates a communication from a communication terminal 1310 (e.g., a telephone) to a PBX switch 1320 via a subscriber line. ANI and other information associated with the subscriber line are captured at the PBX switch 1320 and an ANI match request is generated and communicated to a matching module 1330. The matching module 1330 interrogates one or more databases 1340 with data captured at the PBX switch 1320 to determine whether and to what extent the ANI matches a telephone number obtained during sale validation. The matching process uses the ANI, a transaction identifier and a merchant number to check an appropriate database to see if the information matches a sales transaction record. The results of the match are forwarded back to the originating system.

The results of the matching may include successful match, failed match, partial match, already matched, ANI not present, DNIS not present, and PIN missing. The match result is formatted at the matching module 1330 to be suitable for updating a client (e.g., merchant) database 1350. The client database update may be performed in real-time or batch mode.

The match result is also formatted at the matching module 1330 to make the match result suitable for the PBX switch 1320 to provide (e.g., by generating or selecting) a message associated with the match results to the user. A message provided to the user from the PBX switch 1320 may be in a form of an audio message notifying the user of a successful subscriber line validation.

In an exemplary embodiment of the present invention, an inbound request packet is a 144 byte packet, with 11 individual fields (excluding the length field), each of which may be delimited by a comma.

In example of such packet may be as follows:

| | | | | | | | | | | |
|---|---|---|---|---|---|---|---|---|---|---|
| Name | MSG | MSG- | Call | Orig | ORIG | ANI | DAT | DATA | DNIS | PIN |
| | Type | Sub | ID | Type | | | A B | C | | |
| | | Type | | | | | | | | |

Example Message:

7CallCenter29,001,IGT Test,5256,T,606,4089780959,,,5452,

NAME—Call Center Identification (Usually name of the system forwarding the request or the server hosting the application)

MSG TYPE—Type of message

MSG SUBTYPE—Information on the message, to enable the application to route accordingly if needed

CALLID—Unique Call Id used associate the request—response by system

ORIGTYPE—Type of origination or termination equipment for call

ORIG—Origination resource

ANI—Caller's ANI or phone # dialed if outbound call event

DATA_B—Data field

DATA_C—Data field

DNIS—number dialed inbound call only. If outbound, merchant number associated with merchant.

PIN—PIN used to id sales transaction (not required)

The response packet from the application is a 130 byte packet, with 11 fields each delimited by a comma.

An example of such packet may be as follows:

| | | | | | | | | | |
|---|---|---|---|---|---|---|---|---|---|
| Name | MSG | Call | Ack/ | Routing | ANI | DAT | Response | DNIS | PIN |
| | Type | ID | N | info | | A_B | Code | | |

Example Message:

AVIOR,601,5256,A,,4089780959,,15,5452,

NAME—Call Center Identification (Usually name of the system forwarding the request or the server hosting the application)

MSG TYPE; Type of message

CALLID: Unique Call Id used to associate the request

RESP: Acknowledgement to the message (A/N)

Route: The route for the inbound call to take, screen to present for outbound call associated with the response.

ANI: Caller's ANI or number dialed.

DATA_B: Data field

Response Code: The results of the match.

DNIS—number dialed inbound call only. If outbound, # associated with merchant.

PIN—PIN used to id sales transaction (not required)

Once the response has been presented to the user, the account in the customer management system 72 must be updated to indicate a new status, as well as a provisioning system. This response may be posted or batched to merchant 50 (see FIG. 4) according to the merchant requirements.

CM/PROV update record:

Request Message Format (Post example):

http://ClientProvidedURL//ani=?&uniqueid=?resp=?

Then the systems send a response. Depending on CM/PROV system response to the update, an originating system may resend or hold for batch but will always log the response for tracking and system failure use.

FIG. 14 shows a diagrammatic representation of components, which are involved in effectuating an outbound telephone call from a validation system (or module) 200 according to an exemplary embodiment of the present invention, cumulatively referred to as module 1400. It should be noted that the components 1420, 1430, and 1440 represented in FIG. 14 may be associated with the transaction processing facility 82 (see FIG. 4). Additionally, communication between a communication terminal (e.g., a telephone set) 1310 and a PBX switch may be effectuated via a local telephone company 166 (see FIG. 4); the user terminal 1410 may correspond to the electronic terminal 52 of FIG. 4. When a user selects an option of an outbound call to the validation system 200, the user (e.g., a purchaser or a merchant) schedules the time at the scheduler 1420 for a dialer 1440 to call the communication terminal 1310 associated with the telephone number provided by the user earlier. A processor module 1430 formats the outbound call request received from the scheduler 1420 and passes the request to the dialer 1440. The dialer 1440 initiates a telephone call to the communication terminal 1310 (e.g., a telephone) and obtains a response from the communication terminal 1310. The response may include no answer, answer no code, and answer right code. An update communication module 1450 communicates the result (e.g., validation data) associated with the response from the communication terminal 1310 to one or more client databases 1350 for an update. The client database update may be effectuated in real-time or batch mode.

In an exemplary embodiment, the present invention may extend to a scenario where a transaction (e.g., a sale) is effectuated via the Internet (e.g., utilizing web services in the form of an on-line store). Furthermore, the present invention may also extend to a scenario where a selection of a payment method as well as a selection of an ANI capture method is performed by a merchant following a verbal or written communication from a purchaser. The latter scenario may be taking place at a convenience store where a user (in this case, a customer) wishes to pay for her soft drink via her telephone bill. The merchant (in this case, a store clerk) obtains telephone number information from the customer, enters the information into a computer, selects the ANI capture method pursuant to the customer's instructions and, in case of an outbound telephone call selection, schedules the date and the time for the call pursuant to customer's instructions. The merchant then receives the PIN number and communicates it to the customer. The customer thus is enabled to place a telephone call to the validation system 200. Thus, the present invention may be practiced where an intermediary (e.g., a store clerk) is receiving data from an end user (e.g., a purchaser) and communicating the data to the validation system 200.

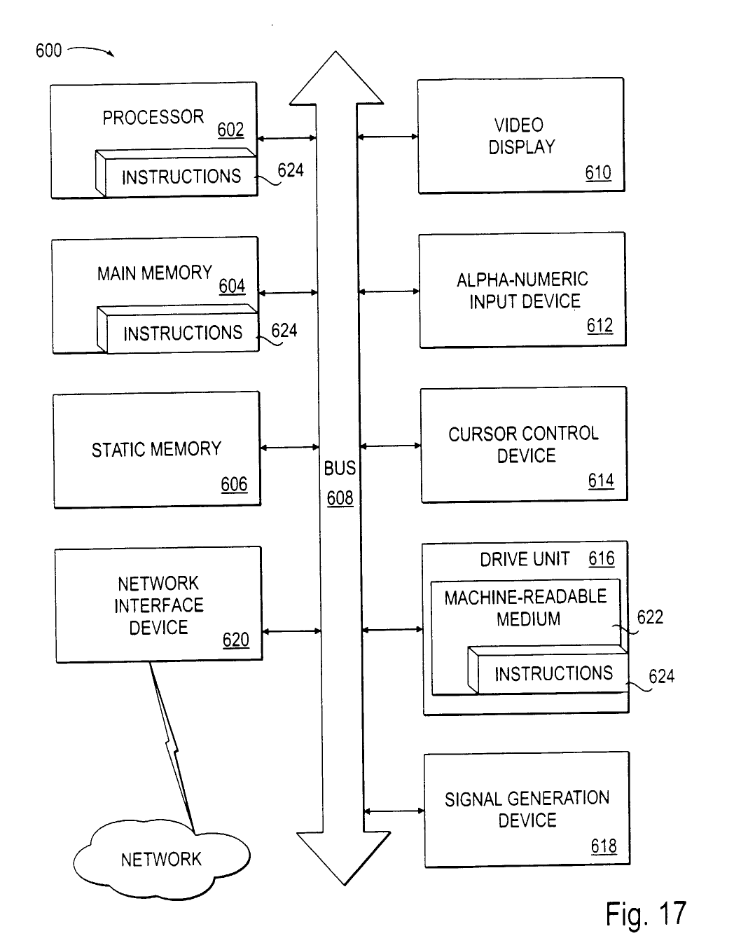

FIG. 17 shows a diagrammatic representation of a machine in the exemplary form of a computer system 600 within which a set of instructions for causing the machine to perform any one of the methodologies discussed above, may be executed. In alternative embodiments, the machine may comprise a network router, a network switch, a network bridge, a set-top box (STB), Personal Digital Assistant (PDA), a cellular telephone, a web appliance or any machine capable of executing a set of instructions that specify actions to be taken by that machine.

The computer system 600 includes a processor 602, a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored a set of instructions (i.e., software) 624 embodying any one, or all, of the methodologies or functions described herein. The software 624 is also shown to reside, completely or at least partially, within the main memory 604 and/or within the processor 602. The software 624 may further be transmitted or received via the network interface device 620. For the purposes of this specification, the term “machine-readable medium” shall be taken to include any medium that is capable of storing, encoding or carrying a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to validate a subscriber line of a communication network, the method including:
receiving a billing telephone number (BTN) associated with the a subscriber line;
receiving a selection of one of a plurality of operations for a validation system to obtain line identification data of the subscriber line, wherein the plurality of operations include:
receiving an inbound communication at the validation system from a communication terminal associated with the subscriber line, and
initiating an outbound communication from the validation system to the communication terminal associated with the subscriber line; and
responsive to a selected operation, obtaining the line identification data of the subscriber line.

2. The method of claim 1, wherein the line identification data is an automatic number identification (ANI).

3. The method of claim 2, including identifying the BTN as a valid billable telephone number.

4. The method of claim 2, including:
identifying the selected operation as an operation of receiving the inbound communication from the communication terminal associated with the subscriber line; and
receiving the inbound communication.

5. The method of claim 4, wherein receiving the inbound communication is effectuated via a private branch exchange (PBX) switch.

6. The method of claim 5, including interrogating one or more databases with the line identification data to obtain validation data associated with the subscriber line.

7. The method of claim 6, including:
formatting the validation data to be suitable for updating a client database with the validation data; and
updating the client database with the validation data.

8. The method of claim 6, including formatting the validation data to be suitable for updating the PBX switch with the validation data.

9. The method of claim 8, including communicating a response associated with the validation data to the communication terminal associated with the subscriber line.

10. The method of claim 3, including:
identifying the selected operation as initiating the outbound communication with the communication terminal associated with the subscriber line; and
initiating the outbound communication.

11. The method of claim 10, including:
obtaining scheduling information to schedule a telephone call event to a telephone line number associated with the BTN;
effectuating the telephone call event to the telephone line number associated with the BTN to obtain validation data associated with the subscriber line; and
updating a client database with the validation data.

12. The method of claim 1, wherein:
the BTN is received from one or more of a group including a vendor and a user; and
the selected operation is received from one or more of the group.

13. A system to validate a subscriber line of a communication network, the system including:
a communication module to receive a billing telephone number (BTN) associated with the subscriber line, the communication module being capable of communicating with a communication terminal via the communication network;
a selection module to allow a selection among a plurality of mechanisms to establish communication with the subscriber line, wherein the plurality of mechanisms include:
an inbound telephone call processing mechanism to receive an inbound communication, and
an outbound telephone call processing mechanism to receive an outbound communication,
wherein the communication module is further to obtain the line identification data of the subscriber line using a selected mechanism of the plurality of mechanisms.

14. The system of claim 13, including a BTN validation module to identify the BTN as a valid billable telephone number.

15. The system of claim 13, including a telephone network switch in communication with the subscriber line.

16. The system of claim 15, wherein the telephone network switch is a private branch exchange (PBX) switch.

17. The system of claim 16, wherein the PBX switch includes a capture module to obtain the line identification data of the subscriber line.

18. The system of claim 17, wherein the capture module is an automatic number identification (ANI) capture module.

19. The system of claim 18, including:
an interrogation module in communication with the PBX switch to obtain validation data associated with an ANI captured by the capture module; and
a match database coupled with the interrogation module.

20. The system of claim 19, including:
a first formatting module to format the validation data to be suitable for updating a client database with the validation data, and
a second formatting module to format the validation data to be suitable for updating the PBX switch with the validation data.

21. The system of claim 20, including a response module in communication with the second formatting module and capable of communicating with a communication terminal associated with the subscriber line.

22. The system of claim 18, including:
a scheduler to schedule a telephone call event to a predetermined telephone line number;
a dialer to effectuate the telephone call event to the predetermined telephone line number via the subscriber line;
a processor module in communication with the dialer to obtain validation data associated with the subscriber line;
a client database; and
an update communication module to update the client database with the validation data.

23. A system to validate a subscriber line of a communication network, the method including:
means for receiving a billing telephone number (BTN) associated with the a subscriber line;
means for receiving a selection of one of a plurality of means for a validation system to obtain line identification data of the subscriber line, wherein the plurality of means include
means for receiving communication at the validation system from a communication terminal associated with the subscriber line, and
means for initiating an outbound communication from the validation system to the communication terminal associated with the subscriber line;
means for obtaining the line identification data of the subscriber line responsive to a selected operation.

24. A machine-readable medium for storing a set of instructions that, when executed by a machine, cause the machine to:
receive a billing telephone number (BTN) associated with the a subscriber line;
receive a selection of one of a plurality of operations for a validation system to obtain line identification data of the subscriber line, wherein the plurality of operations include:
receiving an inbound communication at the validation system from a communication terminal associated with the subscriber line, and
initiating an outbound communication from the validation system to the communication terminal associated with the subscriber line; and
responsive to a selected operation, obtain the line identification data of the subscriber line.
